(19) United States
(12) Patent Application Publication
(10) Pub. No.: US 2026/0259564 A1
(43) Pub. Date: Sep. 3, 2026

(54) CONTROL DEVICE, CONTROL METHOD, AND RECORDING MEDIUM

(71) Applicant: NEC Corporation, Tokyo (JP)

(72) Inventor: Manao MACHIDA, Tokyo (JP)

(73) Assignee: NEC Corporation, Tokyo (JP)

(21) Appl. No.: 19/163,020

(22) PCT Filed: Mar. 24, 2023
(86) PCT No.: PCT/JP2023/011920

§ 371 Date: Sep. 8, 2025

(51) Int. Cl. G05D 1/229; G05D 1/644; G05D 1/695; G05D 111/30

(52) U.S. Cl. CPC G05D 1/229; G05D 1/644; G05D 1/695; G05D 2111/32

(57) ABSTRACT

A control device includes: a communication unit configured to receive a movement plan representing a movement route of another robot; a setting unit configured to set a movement plan representing a route that is different from the movement route along the movement route while keeping a distance allowing communication with the another robot, from the received movement plan of the another robot and a movement plan of an own robot; and a control unit configured to control movement of the own robot in accordance with the set movement plan.

### TECHNICAL FIELD

The present invention relates to technical fields of a control device, a control method, and a recording medium.

### BACKGROUND ART

A system in which a plurality of robots work in coordination is called a multi-agent system. In a multi-agent system, each robot determines its own action based on information observed by its own sensor and local communication with a nearby robot.

Particularly in local communication between mobile robots, generally, when the distance between the communicating robots exceeds a certain limit, data cannot be transmitted or received, leading to a communication disconnection. Therefore, Patent Literature 1 proposes a method of detecting a communication disconnection between robots and moving the robots so as to restore communication. Furthermore, Non-Patent Literature 1 proposes a method of maintaining communication by quantifying the value of the strength of communication across the entire multi-agent system and placing restrictions on the distance between robots so that this value remains a certain level or more.

### CITATION LIST

### Patent Literature

Patent Literature 1: Japanese Unexamined Patent Application Publication JP-A 2017-062768

### Non-Patent Literature

Non-Patent Literature 1: Cai, D., Wu, S., & Deng, J. (2017). Distributed Global Connectivity Maintenance and Control of Multi-Robot Networks. IEEE Access, 5, 9398-9414.

### SUMMARY OF INVENTION

### Technical Problem

However, there is a problem that high-frequency communication and sensing consume more power compared to low-frequency communication and sensing, because a robot consumes a certain amount of power every time it performs communication and sensing. This is because, for example, even if the techniques described in Patent Literature 1 and Non-Patent Literature 1 are used, communication between robots occurs frequently.

An object of the present invention is to provide a mechanism for maintaining communication between robots with a small number of communications, in light of the aforementioned issue.

### Solution to Problem

A control device as an aspect of the present invention includes: a communication unit configured to receive a movement plan representing a movement route of another robot; a setting unit configured to set a movement plan representing a route that is different from the movement route along the movement route while keeping a distance allowing communication with the another robot, from the received movement plan of the another robot and a movement plan of an own robot; and a control unit configured to control movement of the own robot in accordance with the set movement plan.

Further, a control method as another aspect of the present invention includes: receiving a movement plan representing a movement route of another robot; setting a movement plan representing a route that is different from the movement route along the movement route while keeping a distance allowing communication with the another robot, from the received movement plan of the another robot and a movement plan of an own robot; and controlling movement of the own robot in accordance with the set movement plan.

Further, a non-transitory computer-readable recording medium as an aspect of the present invention has a program recorded thereon, and the program includes instructions for causing a computer to execute processes to: receive a movement plan representing a movement route of another robot; set a movement plan representing a route that is different from the movement route along the movement route while keeping a distance allowing communication with the another robot, from the received movement plan of the another robot and a movement plan of an own robot; and control movement of the own robot in accordance with the set movement plan.

### Advantageous Effects of Invention

According to the present invention, it is possible to maintain communication between robots with a small number of communications.

### BRIEF DESCRIPTION OF THE DRAWINGS

FIG. 1 is a block diagram showing a configuration example of a system in a first example embodiment of the present invention.

FIG. 2 is a flowchart of the system in the first example embodiment of the present invention.

FIG. 3 is a diagram showing a reference waypoint sequence and a received waypoint sequence in one example of the first example embodiment of the present invention.

FIG. 4 is a diagram showing a waypoint sequence after execution of step 1 in the one example of the first example embodiment of the present invention.

FIG. 5 is a diagram showing a waypoint sequence after execution of step 2 in the one example of the first example embodiment of the present invention.

FIG. 6 is a block diagram showing a configuration example of a system in a second example embodiment of the present invention.

FIG. 7 is a diagram illustrating a first starting point and a child robot of the starting point in one example of the second example embodiment of the present invention.

FIG. 8 is a diagram illustrating a second starting point and a child robot of the starting point in the one example of the second example embodiment of the present invention.

FIG. 9 is a diagram illustrating a third starting point and a child robot of the starting point in the one example of the second example embodiment of the present invention.

FIG. 10 is a diagram showing a difference between the reference waypoint sequence and the waypoint sequence set in step 2 in the one example of the first example embodiment of the present invention.

FIG. 11 is a diagram showing a waypoint sequence set in step 2 when a denser waypoint sequence representing the same route as in the one example of the first example embodiment of the present invention is an input.

FIG. 12 is an explanatory diagram of first processing in step 3 in one example of a third example embodiment of the present invention.

FIG. 13 is a diagram showing a waypoint sequence after the first processing in step 3 in the one example of the third example embodiment of the present invention.

FIG. 14 is an explanatory diagram of second processing in step 3 in the one example of the second example embodiment of the present invention.

FIG. 15 is a diagram showing a waypoint sequence set in step 3 in the one example of the second example embodiment of the present invention.

FIG. 16 is a block diagram showing an example of a hardware configuration of a control device according to the first example embodiment of the present invention.

FIG. 17 is a diagram showing a formula used in the example embodiments of the present invention.

FIG. 18 is a block diagram of a control device according to a fourth example embodiment of the present invention.

### DESCRIPTION OF EXAMPLE EMBODIMENTS

Next, example embodiments of the present invention will be described in detail with reference to the drawings. In the following description, when there are a plurality of identical or similar elements, a common reference numeral may be used to describe the respective elements without distinguishing them, and a branch number may be added to the common reference numeral to distinguish and describe the respective elements.

### First Example Embodiment

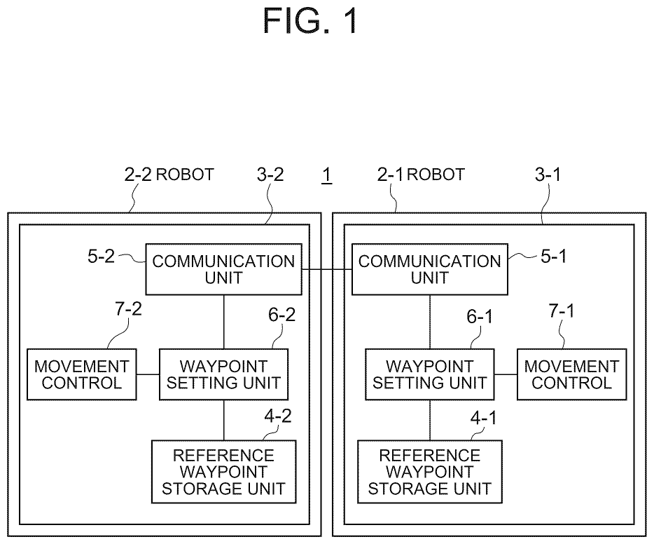

An example of a configuration of a system 1 according to a first example embodiment is shown in FIG. 1. The system 1 includes two robots 2. Further, each robot 2 includes a control device 3.

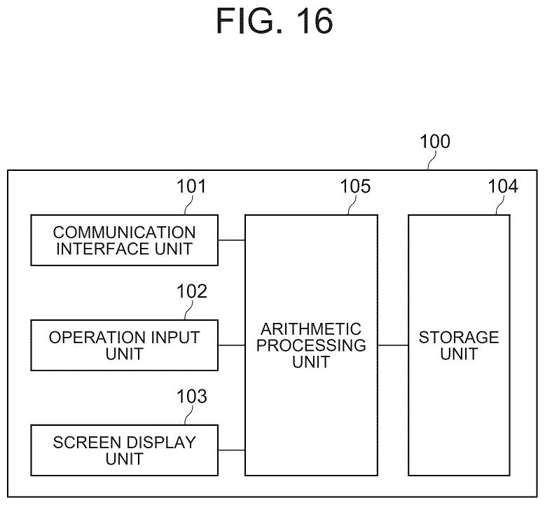

For example, as shown in FIG. 16, each control device 3 can be enabled by a communication interface unit 101, an operation input unit 102 such as a keyboard and a mouse, a screen display unit 103 such as a liquid crystal display, a storage unit 104 such as a memory and a hard disk, an arithmetic processing unit 105 including one or more CPUs (Central Processing Units), and a program 110. The program 110 is loaded to the storage unit 104 from an external computer-readable storage medium, for example, at the time of start-up of the control device 3, and controls the operation of the arithmetic processing unit 105 to enable a reference waypoint storage unit 4, a communication unit 5, a waypoint setting unit 6 and a movement control unit 7 that are shown in FIG. 1 on the arithmetic processing unit 105.

The reference waypoint storage unit 4 stores a waypoint sequence that is route information planned for the robot 2. The waypoint sequence is also referred to as plan information. A waypoint indicates a point through which the robot needs to pass. The waypoint is also referred to as a point. The waypoint is expressed as a pair of position and time. The waypoint requests the robot to reach a designated position at a designated time. That is to say, a waypoint (p, t) is a route that the robot reaches a position p at a time t.

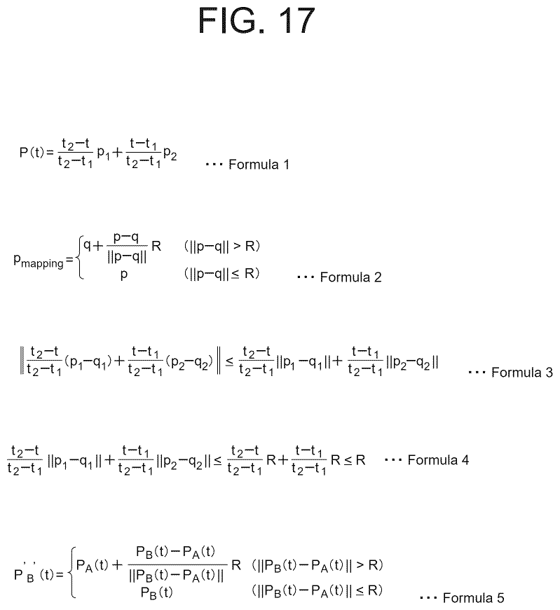

Further, there is a more restricted route designation method using a waypoint sequence, for example, designating a route between waypoints on the assumption that the robot performs a uniform linear motion. That is to say, a route between two waypoints ((p₁, t₁), (p₂, t₂)) is defined as shown by Formula 1 in FIG. 17. Here, a function P(t) in Formula 1 is a function that returns, for an input time t, a position where the robot is present at the time. Since a position where the robot is present at each time is designated, a route can be expressed by the function P(t).

In this example embodiment, a route is designated from a waypoint sequence by this more restricted route designation method. However, the robot does not necessarily need to perform a uniform linear motion. In that case, the function P(t) only needs to show a position where the robot is present at a time t, and is not limited to the form shown in Formula 1.

The reference waypoint storage unit 4 stores a previously determined route considering only the convenience of the robot 2. That is to say, this route does not consider communication maintenance between robots and, when a plurality of robots move in accordance with the waypoint sequences stored in their own reference waypoint storage units 4, there is a risk of falling into a situation where communication is mutually disconnected.

The communication unit 5 transmits and receives a waypoint sequence between its own robot 2 and the other robot 2. The two robots 2 are separated into a robot on a side of transmitting a waypoint sequence and a robot on a side of receiving the waypoint sequence. Here, for convenience of description, it is assumed that a robot 2-1 is defined as a robot that transmits a waypoint sequence and a robot 2-2 is defined as a robot that receives a waypoint sequence. In this case, the communication unit 5-1 of the robot 2-1 transmits a waypoint sequence representing its own currently planned route, and the communication unit 5-2 of the robot 2-2 receives the waypoint sequence representing the currently planned route of the robot 2-1. Moreover, the communication unit 5 can exchange data according to purposes other than a waypoint sequence. For example, in the case of a purpose such that a plurality of robot are used to monitor a surrounding area, the robots may communicate with each other regarding the presence or absence of suspicious objects.

The communication unit 5 performs communication using radio waves, sound waves and the like, and a communication range is determined in advance in these communication methods. The communication range is a range in which communication is assumed to be possible in consideration of the attenuation of radio waves, sound waves and the like. When robots are out of a mutual communication range, there is a risk that communication will not succeed and they may fall into communication disconnection. In most cases, the communication range depends on the distance and becomes a circle (spherical) with the robot at its center. However, the communication range may be determined in consideration of factors other than the distance (for example, obstacle).

The waypoint setting unit 6 sets, as its own planned route, a waypoint sequence considering communication maintenance from a waypoint sequence stored in its own reference waypoint storage unit 4 and a waypoint sequence of the other robot 2 received by the communication unit 5. Hereinafter, in order to facilitate the description, a waypoint sequence stored in the reference waypoint storage unit 4 will be referred to as a reference waypoint sequence, and a waypoint sequence received by the communication unit 5 will be referred to as a received waypoint sequence. More specifically, the waypoint setting unit 6 sets, as a waypoint sequence, a waypoint sequence that is as close as possible to a waypoint sequence stored in its own reference waypoint storage unit 4 among waypoint sequences representing routes that ensure the position of the robot having transmitted the waypoint sequence and its own position to be within the mutual communication range at all times.

A specific setting procedure is divided into the following two steps;
in step 1, align the time series of the received waypoint sequence and the reference waypoint sequence, and
in step 2, map a waypoint at each time into the mutual communication range.

The respective steps will be described in detail.

In step 1, the waypoint setting unit 6 checks the times of included waypoints one by one for the two waypoint sequences, and in a case where there is a time included in only one of the sequences, adds a waypoint corresponding to the time to the other sequence. The position of the waypoint to be added is determined according to Formula 1. That is to say, a waypoint corresponding to a time t is (P(t), t). However, as an exception for the initial and last waypoints in the waypoint sequence, the waypoint setting unit 6 sets the initial position and the last position as they are assuming that the robot is originally in the position before the initial time of the waypoint sequence and the robot stays in the position after the last time of the waypoint sequence.

As a result of step 1, the two waypoint sequences always have waypoints corresponding to the same time.

In step 2, the waypoint setting unit 6 calculates a waypoint sequence capable of maintaining communication with the received waypoint sequence from the reference waypoint sequence. To be specific, the waypoint setting unit 6 maps a reference waypoint at each time into the communication range of the received waypoint sequence at the same time. Here, it is assumed that a communication range shared by a plurality of robots is a circle (or a sphere) of radius R about each robot. Further, assuming that a reference waypoint at a certain time t is (p, t) and a received waypoint is (x, t), a position P_{mapping} after mapping is as expressed by Formula 2 shown in FIG. 17.

When the distance between waypoints is greater than a communication distance R, the position after mapping is a position that is closest to p and located in the communication range of q. If p is already in the communication range of q, the mapping does not change the position.

A robot following a route represented by the waypoint sequence after mapping and a robot following a route represented by the received waypoint sequence are in the mutual communication range at all times. This holds for all times, not limited to the time of the mapped waypoint. This is because when two robots move along routes represented by two waypoint sequences ((p₁, t₁), (p₂, t₂)) and ((q₁, t₁), (q₂, t₂)), respectively, the distance between the robots at a time t (t₁≤t≤t₂) has an upper limit as expressed by Formula 3 of FIG. 17.

Here, since all the distances between waypoints after mapping are less than or equal to R, Formula 4 of FIG. 17 holds, and it can be seen that the robots are within the mutual communication range at all the times.

Through steps 1 to 2, a waypoint sequence representing a route for robots to maintain communication with each other can be calculated.

Finally, the movement control unit 7 controls the movement of its own robot in such a manner that, in a case where the waypoint setting unit 6 sets a waypoint sequence, the robot follows a route represented by the set waypoint sequence. Further, in a case where the waypoint setting unit 6 does not set a way point sequence, the movement control unit 7 controls the movement of its own robot in such a manner that the robot follows a route represented by the reference waypoint sequence stored in the reference waypoint storage unit 4. The movement mechanism of the robot can be, for example, a wheeling type movement mechanism, a crawler-type movement mechanism, and a legged movement mechanism, but is not limited thereto.

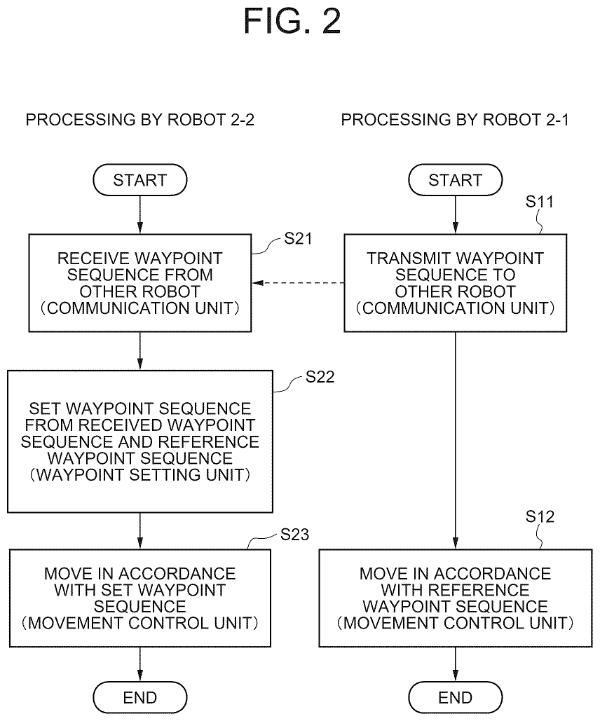

The flow of the processing by the system is shown in FIG. 2. First, one robot 2-1 of the two robots transmits a reference waypoint sequence stored in the reference waypoint storage unit 4-1 through the communication unit 5-1 (step S11). The other robot 2-2 receives the reference waypoint sequence through the communication unit 5-2 (step S21), and the waypoint setting unit 6-2 sets sets a waypoint sequence capable of communication maintenance from the received waypoint sequence and the reference waypoint sequence (step S22). After that, each robot 2 is moved by the movement control unit 7 in accordance with a route represented by the current waypoint sequence. However, in a case where there is a waypoint sequence set by the waypoint setting unit 6, the waypoint sequence becomes the current waypoint sequence, and in a case where there is no waypoint sequence, the reference waypoint sequence becomes the current waypoint sequence. Therefore, in the example shown in FIG. 2, the robot 2-1 moves in accordance with the reference waypoint sequence, and the robot 2-2 moves in accordance with the waypoint sequence set by the waypoint setting unit 6-2.

The robot 2-2 can perform communication maintenance with the robot 2-1 having transmitted the waypoint sequence by moving along a route represented by the waypoint sequence set by the waypoint setting unit 6-2. According to this method, it is possible to maintain communication while limiting the number of communications because frequent communication and observation are not necessary between robots and one robot transmits the waypoint sequence only once after a route is determined with each other (after planning).

### Example of First Example Embodiment

The processing in the first example embodiment will be described in more detail with a specific example.

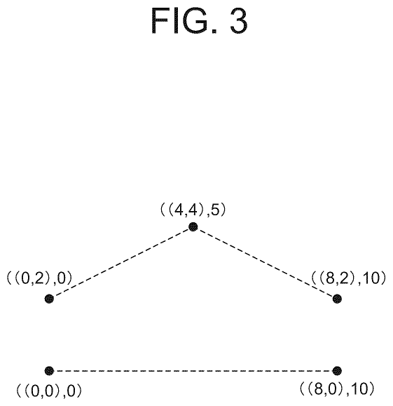

The robot 2-1 and the robot 2-2 store waypoint sequences as shown below in the reference waypoint storage units 4-1 and 4-2, respectively, as shown in FIG. 3;
(((0, 0), 0), (((8, 0), 10)), and
(((0, 2), 0), ((4, 4), 5), ((8, 2), 10)).

First, the robot 2-1 transmits a waypoint sequence to the robot 2-2. The robot 2-2 receives the waypoint sequence and makes the waypoint setting unit 6-2 set a waypoint sequence that is capable of communication maintenance with the robot 2-1.

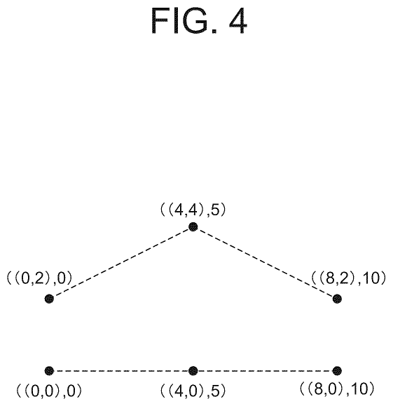

First, the waypoint setting unit 6-2 adds a waypoint corresponding to a time that is present only in one sequence in step 1. That is to say, the waypoint setting unit 6-2 adds a waypoint corresponding to a time 5 that is present only in the received waypoint sequence to the reference waypoint sequence. As a result of the processing in step 1, as shown in FIG. 4, the two waypoint sequences are as shown below,
(((0, 0), 0), ((4, 0), 5), ((8, 0), 10)),
(((0, 2), 0), ((4, 4), 5), ((8, 2), 10)).

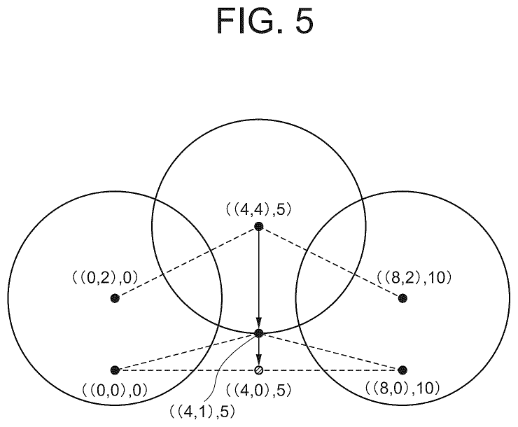

In step 2, the waypoint setting unit 6-2 maps each waypoint of the reference waypoint sequence into the communication range of the received waypoint at the same time. Assuming that the communication range is a circle with a radius of 3 centered on the robot, as shown in FIG. 5, the result of mapping is as follows, where the communication range is 2D (circle), but may be 3D (sphere),
(((0, 0), 0), ((4, 1), 5), ((8, 0), 10)).

At a time 0, the distance between (0, 0) and (0, 2) is less than or equal to 3, and the mapping does not change the position. The same is true on a time 10. At a time 5, the distance between (4, 0) and (4, 4) is 4, and the position (4, 0) is not within the communication range. Therefore, in the communication range, the waypoint is mapped into a position (4, 1) that is closest to the position (4, 0).

Finally, the following is set as a waypoint sequence of the robot 2-2,
(((0, 0), 0), ((4, 1), 5), ((8, 0), 10)).

The movement control units 7-1 and 7-2 of the robots 2-1 and 2-2 move in accordance with routes expressed by the current waypoint sequences, respectively, so that the distance between the two robots remains equal to or less than 3 at all times, and communication maintenance is achieved.

### Second Example Embodiment

In the first example embodiment, the description was limited to the case of two robots. In a second example embodiment, communication maintenance for three or more robots will be described.

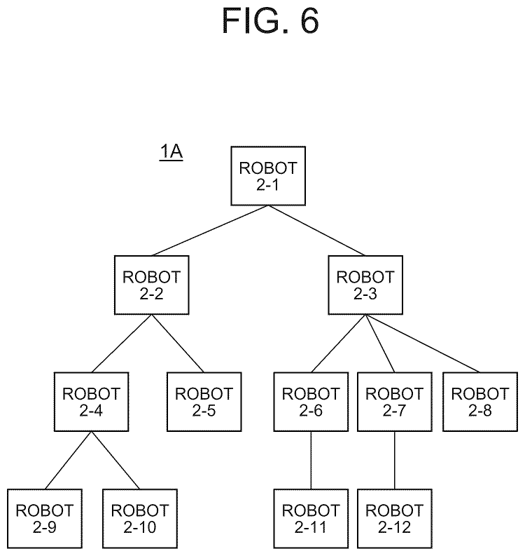

An example of a configuration of a system 1A according to the second example embodiment is shown in FIG. 6. The internal structure of each robot 2 is the same as that of the robot 2 in the first example embodiment. Each robot 2 is equipped with the same control device 3 as that in the first example embodiment. The processing and operation by the robot 2 described below are the processing and operation by the control device of that robot 2.

In the second example embodiment, the system 1A sets a tree structure that is unique for a plurality of robots 2. That is to say, each robot 2 has zero or more child robot, and each robot 2 has one or less parent robot, with only one robot 2 having no parent robot (i.e., having zero parent robot). Herein, when and only when a robot A has a robot B as its child robot, the robot B has the robot A as its parent robot.

This tree structure indicates the order in which the plurality of robots 2 set a waypoint sequence for maintaining communication. A robot without a parent robot is called a root robot. Starting from the root robot, a waypoint sequence is set according to the following steps.

Step 1: The robot 2, which is the starting point, transmits a waypoint sequence representing the current route to all of its child robots 2.

Step 2: All the child robots 2 that have received the waypoint sequence set a waypoint sequence that is capable of maintaining communication with the starting point robot 2 in accordance with the procedure shown in the first example embodiment.

Step 3: Each child robot 2 that has completed the setting of the waypoint sequence, if it has (one or more) child robots 2 of its own, repeats Steps 1 to 3 with itself as the starting point.

### Example of Second Example Embodiment

The abovementioned processing will be described with a simple specific example.

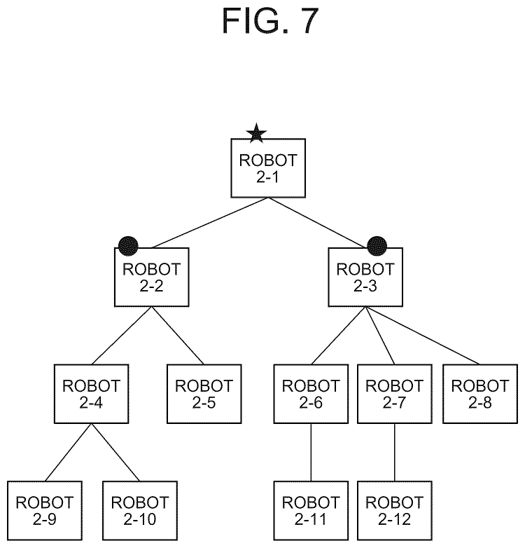

First, as shown in FIG. 7, the root robot 2-1 is the starting point represented by a star. Then, two child robots 2-2 and 2-3 of the root robot 2-1, which are represented by circles, each receive a waypoint sequence from the root robot 2-1 and set a waypoint sequence that is capable of maintaining communication with the root robot 2-1.

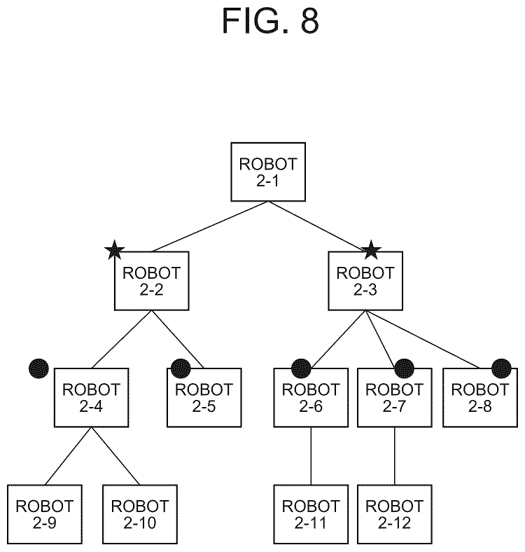

Next, as shown in FIG. 8, the two child robots 2-2 and 2-3 mentioned above become the starting points and transmit waypoint sequences to child robots 2-4 to 2-5 and child robots 2-6 to 2-8, respectively. At this time, the waypoint sequences to be transmitted are waypoint sequences set by the respective robots 2-2 and 2-3 mentioned above. The child robots 2-4 to 2-8 having received the waypoint sequences set their own waypoint sequences from the received waypoint sequences. These processes are performed in parallel for each of the starting point and the child robots of the starting point.

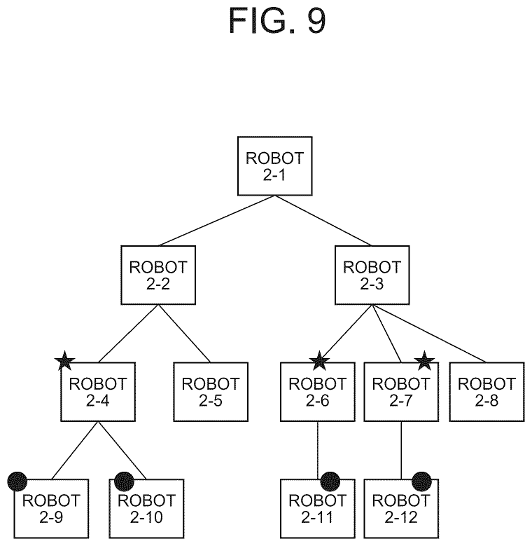

Finally, as shown in FIG. 9, the robots 2-4, 2-6, and 2-7 each having its own child robot among the child robots 2-4 to 2-8 mentioned above become the starting points, respectively, and transmit waypoint sequences to their child robots 2-9 to 2-10, 2-11, and 2-12. The child robots 2-9 to 2-12 having received the waypoint sequences set waypoint sequences. Since the child robots 2-9 to 2-12 do not have their own child robots, the steps are not repeated any more.

As a result of the above procedure, all of the child robots can each set a waypoint sequence that is capable of maintaining communication with the parent robot, and communication maintenance across all the plurality of robots is achieved.

### Third Example Embodiment

A configuration of a system according to a third example embodiment is the same as that of the first example embodiment. In the third example embodiment, only processing by the waypoint setting unit 6 is different from that in the first example embodiment. More specifically, an object is to set a better waypoint sequence by adding step 3 to the processing by the waypoint setting unit 6.

As will be described in detail later, the setting of a waypoint sequence in the first embodiment has a tendency that, when a route is represented by a sparse waypoint sequence, the deviation between a waypoint sequence set for communication maintenance and an original waypoint sequence becomes significant. On the other hand, in a case where a route is represented by a dense waypoint sequence, the deviation can be is limited to being small, but there is a problem that the number of communicating waypoints increases, resulting in increase in communication cost.

Accordingly, in step 3, an ideal route is calculated from a route represented by a received waypoint sequence and a route represented by a reference waypoint sequence, and the distance between the calculated ideal route and the route represented by the waypoint sequence to be set is limited to being equal to or less than a given value, so that the deviation of the waypoint sequences is limited to being small.

A route represented by a received waypoint sequence is denoted by P_{A}, a route represented by a reference waypoint sequence is denoted by P_{B}, and a route represented by a waypoint sequence set after performing step 2 is denoted by P_{B}′. At this time, an ideal route P_{B}″ that is capable of maintaining communication with a robot moving in accordance with the route P_{A} and is closest to the route P_{B} is expressed by Formula 5 of FIG. 17.

The threshold value of a gap between routes is denoted by D. The smaller this threshold value is, the closer a waypoint sequence is set to the original route, but the number of waypoints increases. The threshold value is appropriately set in consideration of this trade-off.

The waypoint setting unit 6 performs the following processing using the waypoint sequence set in step 2 as a comparison sequence.

Step 3: A route represented by the comparison sequence and the route P_{B}″ are compared with each other for each time, and if there is a time t where the difference in distance is greater than D, a waypoint (P_{B}″(t), t) is added to the comparison sequence, and the processing is repeated with the sequence with addition as a new comparison sequence. If there is not such a time t, the comparison sequence at the time is set as a waypoint sequence.

A route represented by the waypoint sequence set in step 3 is a waypoint sequence in which the distance from the ideal route P_{B}″ is equal to or less than D at any time, which is close to the original route P_{B}.

According to the third example embodiment, it is possible to set a waypoint sequence that is closer to the original route and is capable of communication maintenance by appropriately setting a threshold value, while suppressing an increase in the number of waypoints affecting the amount of information to be communicated.

### Example of Third Example Embodiment

The processing and effect in the third example embodiment will be described using the same example as that of the first example embodiment.

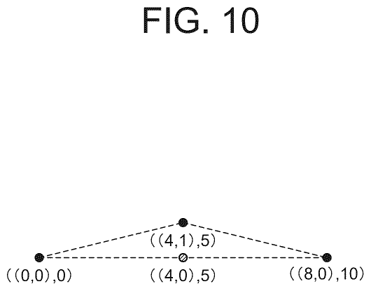

In this case, the difference between a route represented by the waypoint sequence set in step 2 and a route represented by the original waypoint sequence matches the area of a region surrounded by a dotted line shown in FIG. 10. That is to say, the difference is 4. Herein, suppose that waypoint sequences after step 1 are given as shown below;
(((0, 0), 0), ((2, 0), 2.5), ((4, 0), 5), ((6, 0), 7.5), ((8, 0), 10)), and
(((0, 2), 0), ((2, 3), 2.5), ((4, 4), 5), ((6, 3), 7.5), ((8, 2), 10)).

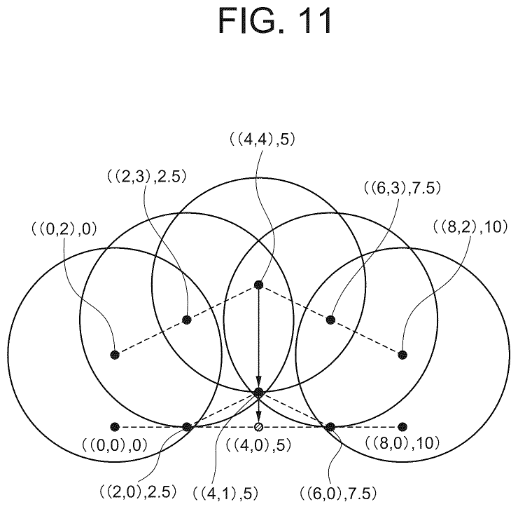

In this case, although these waypoint sequences represent the same route as in FIG. 3, the waypoint sequence set in Step 2 is as shown in FIG. 11;
(((0, 0), 0), ((2, 0), 2.5), ((4, 1), 5), ((6, 0), 7.5, ((8, 0), 10)).

The difference between this waypoint sequence and the original waypoint sequence is 2, indicating that when the original waypoint sequence is given more densely, the deviation of the set waypoint sequence becomes smaller.

In order to solve the problem that the difference between the waypoint sequence set in step 2 and the reference waypoint sequence depends on the density of waypoint sequence, in step 3, the distance at each time between the ideal route and the waypoint sequence set in step 2 is compared. Here, the ideal route (Formula 5) matches a route represented by a waypoint sequence below;
(((0, 0), 0), ((2, 0), 2.5), ((4, 1), 5), ((6, 0), 7.5), ((8, 0), 10)).

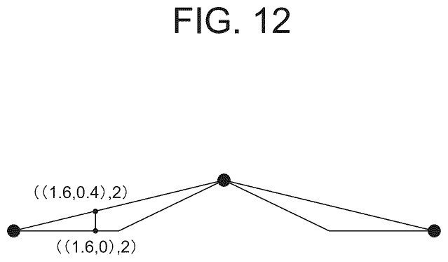

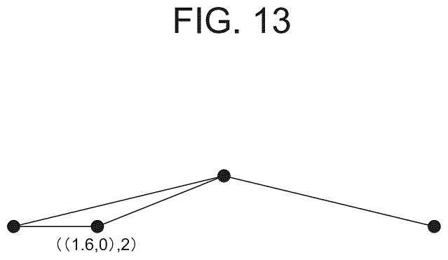

In the case of a threshold value D=0.4, a time at which the distance between the comparison sequence and the ideal route exceeds the threshold value first is a time 2 as shown in FIG. 12. Therefore, ((1.6, 0), 2) is added to the comparison sequence, and a sequence with addition becomes a new comparison sequence shown in FIG. 13.

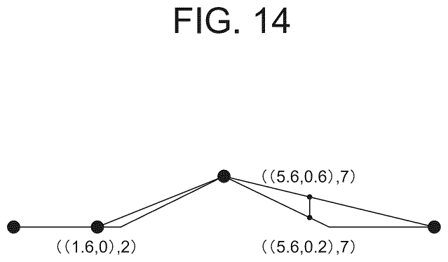

A time at which the distance between the new comparison sequence of FIG. 13 and the ideal route exceeds the threshold value next is a time 7 as shown in FIG. 14, so that ((5.6, 0.2), 7) is added to the new comparison sequence.

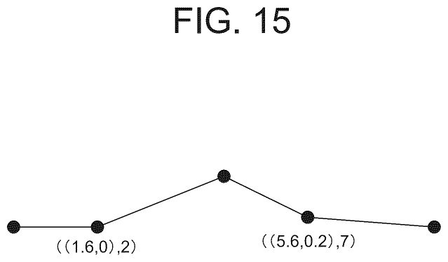

In a new comparison sequence with a waypoint added shown in FIG. 15,
(((0, 0), 0), ((1.6, 0), 2), (4, 1), 5), ((5.6, 0.2), 7), ((8, 0), 10)),
the distance from the ideal route does not exceed the threshold value at any time, so that the processing ends here. The final comparison sequence is set as a waypoint sequence. The set waypoint sequence has a smaller difference from the reference waypoint sequence than the waypoint sequence set in up to step 2, so that it can be seen that a better waypoint sequence is set through step 3. In addition, the increase in the number of waypoints is limited to only two, so that an increase in communication cost can be suppressed.

### Fourth Example Embodiment

Next, a fourth example embodiment of the present invention will be described. In this example embodiment, the overview of the present invention will be described.

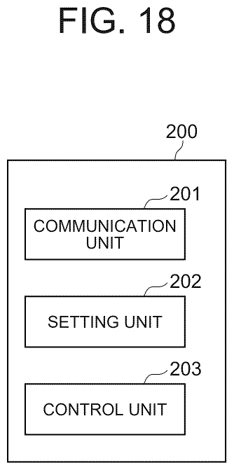

FIG. 18 is a block diagram of a control device 200 according to this example embodiment. Referring to FIG. 18, the control device 200 includes a communication unit 201, a setting unit 202, and a control unit 203.

The communication unit 201 is configured to receive a movement plan representing the movement route of another robot. The setting unit 202 is configured to set a movement plan representing a different route from the movement route along the movement route while keeping a distance allowing communication with the other robot from the movement plan of the other robot received by the communication unit 201 and a movement plan of its own robot. The control unit 203 is configured to control the movement of its own robot in accordance with the movement plan set by the setting unit 202.

The control device 100 configured as described above operates as shown below. First, the communication unit 201 receives a movement plan representing a movement route of another robot. Next, the setting unit 202 sets a movement plan representing a different route from the movement route along the movement route while keeping a distance allowing communication with the other robot from the movement plan of the other robot received by the communication unit 201 and a movement plan of its own robot. Next, the control unit 203 controls movement of its own robot in accordance with the movement plan set by the setting unit 202.

The communication unit 201 can be enabled using a function of the communication unit 5 according to the first example embodiment. The setting unit 202 can be enabled using a function of the waypoint setting unit 6 according to the first example embodiment. The control unit 203 can be enabled using a function of the movement control unit 7 according to the first example embodiment. Therefore, the control device 200 can be enabled using a function of the control device 3 according to the first example embodiment.

According to the control device 100 that is configured and operates as described above, it is possible to maintain communication between robots with a reduced number of communications. The reason is that communication maintenance is achieved in the process of the movement plan.

Although the present invention has been described above with reference to the above example embodiments, the present invention is not limited to the example embodiments described above. The configuration and details of the present invention can be changed in various manners that can be understood by one skilled in the art within the scope of the present invention.

For example, the control device may use a GPU (Graphic Processing Unit), a DSP (Digital Signal Processor), an MPU (Micro Processing Unit), an FPU (Floating Number Processing Unit), a PPU (Physics Processing Unit), a TPU (Tensor Processing Unit), a quantum processor, a microcontroller, or a combination of these, instead of the abovementioned CPU.

REFERENCE SIGNS LIST

| 1, 1A | system |
|---|---|
| 2, 2-1 to 2-12 | robot |
| 3, 3-1, 3-2 | control device |
| 4, 4-1, 4-2 | reference waypoint storage unit |
| 5, 5-1, 5-2 | communication unit |
| 6, 6-1, 6-2 | waypoint setting unit |
| 7, 7-1, 7-2 | movement control unit |

What is claimed is:

1. A control device comprising:
a memory containing program instructions; and
a processor coupled to the memory, wherein the processor is configured to execute the program instructions to:
receive a movement plan representing a movement route of another robot;
set a movement plan representing a route that is different from the movement route along the movement route while keeping a distance allowing communication with the another robot, from the received movement plan of the another robot and a movement plan of an own robot; and
control movement of the own robot in accordance with the set movement plan.

2. The control device according to claim 1, wherein
the movement plan includes a sequence of points through which the robot needs to pass.

3. The control device according to claim 2, wherein
the point contains a position and a time.

4. The control device according to claim 3, wherein in the setting, the processor is configured to execute the program instructions to:
by adding a point containing a same time as a time contained by only one movement plan of the received movement plan of the another robot and the movement plan of the own robot to another movement plan, adjust both the movement plans to include points containing a same time; and
regarding the respective points at the same time included by both the movement plans after the adjustment, correct the position of the point in the movement plan of the own robot in such a manner that the point included by the movement plan of the own robot falls within a communication range of the point of the received movement plan of the another robot.

5. The control device according to claim 4, wherein in the setting, the processor is configured to execute the program instructions to:
compare the movement plan of the own robot after the correction with the received movement plan of the another robot and an ideal movement plan capable of communication maintenance, for each time; and
when a distance between the points of both the movement plans is larger than a predetermined threshold value at a certain time, add a point containing the time and a position at which the robot is present in the ideal movement plan at the time, to the movement plan of the own robot after the correction.

6. The control device according to claim 1, wherein in the receiving, the processor is configured to execute the program instructions to
receive the movement plan of the another robot from the robot that is a parent of the own robot in a tree structure determined for a plurality of robots.

7. The control device according to claim 6, wherein the processor is further configured to execute the program instructions to
transmit the set movement plan to the robot that is a child of the own robot in the tree structure.

8. A system comprising a plurality of the control devices according to claim 1.

9. A control method comprising:
receiving a movement plan representing a movement route of another robot;
setting a movement plan representing a route that is different from the movement route along the movement route while keeping a distance allowing communication with the another robot, from the received movement plan of the another robot and a movement plan of an own robot; and
controlling movement of the own robot in accordance with the set movement plan.

10. A non-transitory computer-readable recording medium with a program recorded thereon, the program comprising instructions for causing a computer to execute processes to:
receive a movement plan representing a movement route of another robot;
set a movement plan representing a route that is different from the movement route along the movement route while keeping a distance allowing communication with the another robot, from the received movement plan of the another robot and a movement plan of an own robot; and
control movement of the own robot in accordance with the set movement plan.
